(19) United States
(12) Patent Application Publication
(10) Pub. No.: US 2010/0214269 A1
(43) Pub. Date: Aug. 26, 2010

(54) OPTICAL TOUCH MODULE

(75) Inventors: Wei Chung Wang, Hsin-Chu City (TW); Hui Hsuan Chen, Hsin-Chu City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PixArt Imaging Inc., Hsin-Chu City (TW)

(21) Appl. No.: 12/512,630

(22) Filed: Jul. 30, 2009

(30) Foreign Application Priority Data
Feb. 25, 2009 (TW) 098202836

(51) Int. Cl. G06F 3/042

(52) U.S. Cl. 345/175; 341/14

(57) ABSTRACT

An optical touch module is adapted to provide a touch area. At least one sensor is disposed at a corner of the touch area. The optical touch module includes at least one light emitting element and at least one waveguide element. The waveguide element is disposed on at least one side of the touch area, for guiding and emitting light rays provided by the light emitting element to the touch area. Each waveguide element includes a light incident surface and a light emitting surface. The light incident surface faces the light emitting element. The light emitting surface faces the touch area. Thereby, the light rays emitted from the light emitting element are distributed on the touch area through the waveguide element, so as to lower the luminance of the light emitting element and reduce the current consumption.

### CROSS-REFERENCE TO RELATED APPLICATIONS

This non-provisional application claims priority under 35 U.S.C. §119(a) on Patent Application No(s). 098202836 filed in Taiwan, R.O.C. on Feb. 25, 2009 the entire contents of which are hereby incorporated by reference.

### BACKGROUND OF THE INVENTION

1. Field of Invention

The present invention relates to a touch module, and more particularly to an optical touch module.

2. Related Art

In recent years, for a touch screen (i.e., a touch panel), the conventional mechanical press-button operation is replaced by a direct touch operation with an object or a finger on the screen. When a user touches an icon on the screen, various connecting units are driven by a touch feedback system on the screen according to a preset program, and a vivid video and audio effect is presented on a frame of the screen.

The commonly used touch screens employ resistive, capacitive, acoustic wave, and optical touch modes. A resistive touch screen adopts two sets of indium tin oxide (ITO) conductive layers separated by a spacer, and when applied, upper and lower electrodes are conducted under pressure to detect voltage changes on the screen so as to calculate the contact position for input. A capacitive touch screen adopts capacity changes generated from the combination of static electricity between arranged transparent electrodes and a human body, so as to detect coordinates of the contact position through a generated induced current. An acoustic wave touch screen first converts an electric signal into an ultrasonic wave through a transducer, and then directly transmits the ultrasonic wave through a surface of the touch panel. When the touch panel is used, the ultrasonic wave may be absorbed by contacting a pointer to cause attenuation, and an accurate position of the contact is obtained through comparison and calculation between attenuation amounts before and after use.

An optical touch screen utilizes the principle of light source reception and blocking. When light rays are blocked, the position of a receiver that is unable to receive a signal is obtained, and an accurate position thereof is further determined. Components of the optical touch screen include a glass substrate, a light emitting device, a light receiver, and a lens. The light emitting device and the light receiver are disposed at an upper right corner of the glass substrate, and light-reflecting bars are disposed on the left side and lower side of the glass substrate. The far-end light-reflecting bars are illuminated by the light emitting device, and when a finger or a contact object blocks the light rays, the light receiver may collect a relative position of the finger or the contact object on the glass substrate through the lens.

As the conventional optical touch screen employs the light-reflecting bars to reflect the light rays emitted from the light emitting device to detect the relative position of the finger or the contact object on the glass substrate, the detection result may be easily affected by ambient light sources. Similarly, the light rays reflected by the light-reflecting bars and the light rays emitted from the light emitting device may exert interactive influences on the light receiver. In addition, as the light emitting device disposed at the upper right corner of the glass substrate is required to illuminate the far-end light-reflecting bars, relatively accurate alignment, great output luminance, and output current are needed.

### SUMMARY OF THE INVENTION

Accordingly, the present invention is an optical touch module, adapted to avoid influences caused by the increase of the ambient light sources due to the use of the light-reflecting bars and the demands of relatively accurate alignment, great output luminance, and output current, and to avoid interactive influences on the light receiver from the light rays reflected by the light-reflecting bars and the light rays emitted by the light emitting device.

According to the present invention, an optical touch module is adapted to provide a touch area. At least one sensor is disposed at a corner of the touch area. The optical touch module comprises a light emitting element and a waveguide element.

The waveguide element is disposed at one side of the touch area, for guiding and emitting light rays provided by the light emitting element to the touch area. The waveguide element comprises a light incident surface and a light emitting surface. The light incident surface faces the light emitting element, and the light emitting surface faces the touch area. A shape of the light incident surface is corresponding to that of the light emitting element. The light emitting surface has a diffusion structure.

The touch area is a polygon, and the waveguide element is disposed at one side of the polygonal touch area.

The light emitting element is located at a corner of the touch area opposite to the sensor. In other words, when the sensor is disposed at a corner of the touch area, the light emitting element is disposed at another corner of the touch area opposite to the sensor.

The optical touch module further comprises a substrate. The substrate is located below the touch area. The light emitting element is located on a surface of the substrate facing the touch area. The substrate is an indium tin oxide (ITO) glass, and the light emitting element is located on a surface of the substrate facing the touch area.

According to the optical touch module provided by the present invention, the waveguide element uniformly distributes light rays emitted from the light emitting element to the touch area surrounded by the waveguide element, such that the sensor receives the light rays emitted from the light emitting surface to the touch area. When the sensor detects that the light rays are blocked, a relative position of an object to be measured on the touch area can be obtained. Thereby, the waveguide element is employed to uniformly distribute the light rays emitted by the light emitting element to the touch area, so as to replace the conventional light-reflecting bars adapted to reflect the light rays emitted by the light emitting element. In this manner, the resistibility of the optical touch module against the ambient light sources is enhanced, thus avoiding interactive influences on the sensor from the light rays emitted by the conventional light emitting element and the light rays reflected by the light-reflecting bars. Meanwhile, the luminance of the light emitting element is decreased, the current consumption is reduced, and the alignment accuracy of the optical touch module is also lowered.

The features and implementations of the present invention are illustrated in detail below in preferred embodiments with the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a top view of an optical touch module according to a first embodiment of the present invention;

FIG. 2 is a top view of an optical touch module according to a second embodiment of the present invention;

FIG. 3 is a top view of an optical touch module according to a third embodiment of the present invention;

FIG. 4 is a side view of an optical touch module according to a fourth embodiment of the present invention; and

FIG. 5 is a schematic view of an adjacent area between a waveguide element and a light emitting element according to a fifth embodiment of the present invention.

### DETAILED DESCRIPTION OF THE INVENTION

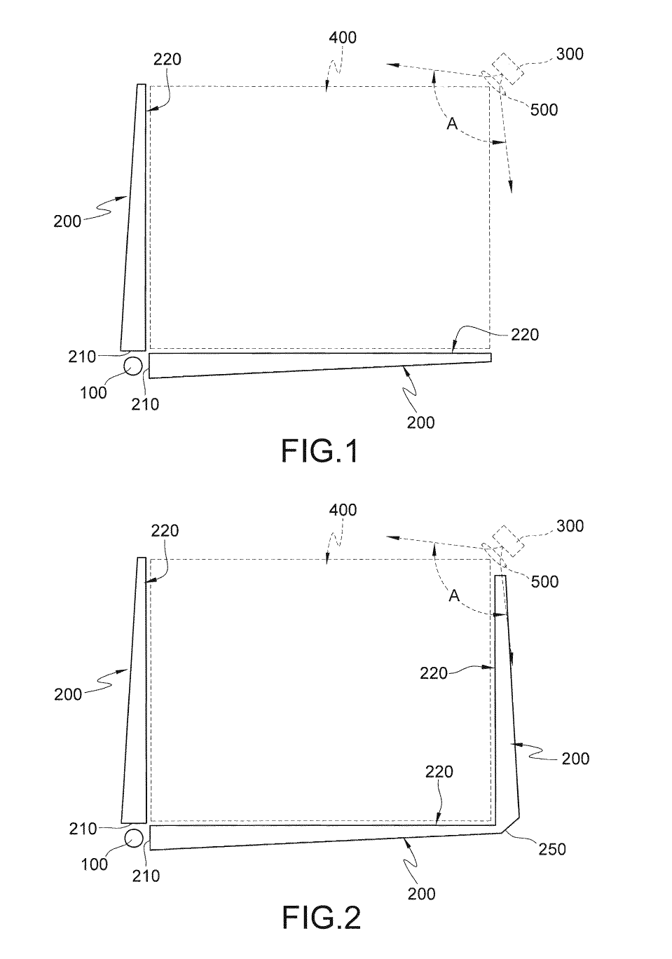

FIG. 1 is a top view of an optical touch module according to a first embodiment the present invention.

Referring to FIG. 1, in this embodiment, the optical touch module is located on a display screen (for example, a screen of a liquid crystal display, a screen of a cathode ray tube display, or an electronic whiteboard), and provides a touch area 400. A sensor 300 is disposed at a corner of the touch area 400.

The optical touch module comprises a light emitting element 100 and a waveguide element 200.

The respective number of the light emitting element 100, the waveguide element 200, and the sensor 300 may be one or more than two. For ease of illustration, in this embodiment, the number of the light emitting element 100 is one, the number of the waveguide element 200 is two, and the number of the sensor 300 is one. However, the present invention is not limited thereto.

The waveguide element 200 is disposed on at least one side of the touch area 400. The touch area 400 is a polygon (for example, a quadrangle, a pentagon, or a hexagon), and the waveguide element 200 is disposed at one side of the polygonal touch area 400.

The waveguide element 200 comprises a light incident surface 210 and a light emitting surface 220.

The light incident surface 210 faces the light emitting element 100. In other words, the light incident surface 210 is adjacent to the light emitting element 100. That is, the light incident surface 210 is attached to a light outgoing surface of the light emitting element 100, or the light incident surface 210 is spaced from the light outgoing surface of the light emitting element 100. The light emitting surface 220 faces the touch area 400.

The optical touch module further comprises a lens 500.

The lens 500 is corresponding to the sensor 300, and is located between the corresponding sensor 300 and the touch area 400. The lens 500 is adjacent to the sensor 300. That is, the lens 500 is attached to a light receiving surface of the sensor 300, or the lens 500 is spaced from the light receiving surface of the sensor 300.

The light emitting element 100 is located at a corner of the touch area 400 opposite to the sensor 300.

In this embodiment, the touch area 400 is a rectangle (quadrangle). The sensor 300 is disposed at a corner of the touch area 400. Thereby, the light emitting element 100 and the sensor 300 may be disposed at the same or different corners of the touch area 400. In other words, the sensor 300 is disposed at a corner of the touch area 400, and the light emitting element 100 is disposed at another corner of the touch area 400 opposite to the sensor 300. The corner where the light emitting element 100 is disposed opposite to the sensor 300 on the touch area 400 may be a corner adjacent to the sensor 300, or a diagonal corner opposite to the sensor 300.

When the light emitting element 100 is disposed at a diagonal position opposite to the sensor 300, two waveguide elements 200 are respectively disposed on two sides of the touch area 400 adjacent to the light emitting element 100. The waveguide element 200 may be in the shape of a wedge with one end close to the light emitting element 100 being thicker and the other end far away from the light emitting element 200 being thinner, or in the shape of a flat panel.

The touch area 400 may also be a polygon having more sides than a pentagon. Thereby, the light emitting element 100 may be disposed at a corner adjacent to the sensor 300, a corner adjacent to but spaced from the sensor 300, or a diagonal corner opposite to the sensor 300.

The light emitting element 100 is adapted to generate and output light rays. The light rays emitted from the light emitting element 100 may be infrared light, visible light, and the like. The light emitting element 100 may be an infrared light emitting diode, a visible light emitting diode, and the like.

The light incident surface 210 is adapted to receive the light rays emitted from the light emitting element 100. A shape of the light incident surface 210 is corresponding to that of the light emitting element 100. The light incident surface 210 may be a smooth surface, for avoiding effects such as light scattering caused by a rough surface of the light incident surface 210 when the light rays from the light emitting element 100 are incident on the light incident surface 210, so as to ensure the incident efficiency of the light rays on the light incident surface 210.

The waveguide element 200 is made of a material different from the ambient air. That is, an index of refraction of the waveguide element 200 differs from that of the ambient air. Due to the difference on the indexes of refraction, the light rays are confined within the waveguide element 200 for transmission after entering the waveguide element 200 through the light incident surface 210.

The light emitting surface 220 is adapted to let the light rays exit the waveguide element 200.

The light emitting surface 220 has a diffusion structure. The diffusion structure may be a grating structure or an irregular structure. When the light rays conducted in the waveguide element 200 are emitted to the diffusion structure, the light rays will no longer be transmitted in the waveguide element 200 due to total reflection. Instead, the light rays exit the waveguide element 200 through refraction by the diffusion structure.

For the diffusion structure, during the molding of the waveguide element 200, the shape and position of the diffusion structure are designed on the mold in advance. Thereby, when the waveguide element 200 is injection-molded or die-cast, the diffusion structure is right located on the light emitting surface 220. The diffusion structure may also be formed (for example, by sand blasting) on the light emitting surface 220 after the waveguide element 200 is injection-molded or die-cast.

The lens 500 is adapted to increase a light-receiving angle A of the sensor 300, that is, the sensor 300 with a relatively small light-receiving angle is enabled by the lens 500 to receive light rays in a larger angle range. Taking this embodiment for example, the touch area 400 is a rectangle (quadrangle), and the four angles of the touch area 400 are all 90°. The light-receiving angle of the sensor 300 is generally smaller than 90°. Thus, when the sensor 300 is disposed at a corner of the touch area 400, only the light rays in a partial angle range can be received, and the light rays within the touch area 400 cannot be completely received. As such, when a finger or any other contact object is placed on the touch area 400 but outside the light-receiving angle range of the sensor 300, the sensor 300 is still unable to sense the relative position of the finger or the contact object on the touch area 400.

Thereby, the light-receiving angle range of the sensor 300 is expanded by disposing the lens 500 between the sensor 300 and the touch area 400. Taking this embodiment for example, the sensor 300 is enabled by the lens 500 to receive light rays in an angle range greater than 90°. That is, when the sensor 300 is disposed at a corner of the touch area 400, as the sensor 300 is capable of receiving light rays in an angle range greater than 90° through the corresponding lens 500, all the light rays within the touch area 400 can be received by one sensor 300 combined with the lens 500.

According to the optical touch module provided by the present invention, after the light emitting element 100 emits light rays, the light rays are first received by the light incident surfaces 210 of the two waveguide elements 200 facing the light emitting element 100. Due to the difference on the indexes of refraction between the waveguide element 200 and the ambient air, the light rays are confined within the two waveguide elements 200 for transmission. Eventually, the light rays exit the two waveguide elements 200 through the diffusion structure on the light emitting surface 220 and are distributed in the touch area 400. All the light rays within the touch area 400 are then received by the sensor 300 through the lens 500.

When a finger or any other contact object is placed on the touch area 400, a part of the light rays emitted from the light emitting surface 40 to the touch area 400 are blocked. Thus, when the sensor 300 is unable to receive the blocked light rays, a relative position of the finger or the contact object on the touch area 400 is determined.

Here, the two waveguide elements 200 are employed to uniformly distribute the light rays emitted by the light emitting element 100 to the touch area 400, so as to replace the conventional light-reflecting bars adapted to reflect the light rays emitted by the light emitting element 100. In this manner, the resistibility of the optical touch module against the ambient light sources is enhanced, thus avoiding interactive influences on the sensor 300 from the light rays emitted by the conventional light emitting element 100 and the light rays reflected by the light-reflecting bars. Meanwhile, the luminance of the light emitting element 100 is decreased, the current consumption is reduced, and the alignment accuracy of the optical touch module is also lowered.

FIG. 2 is a top view of an optical touch module according to a second embodiment of the present invention.

Referring to FIG. 2 in combination with the above embodiment, in this embodiment, one of the two waveguide elements 200 is disposed at one side of the touch area 400 adjacent to the light emitting element 100.

The other of the two waveguide elements 200 is disposed at another side of the touch area 400 adjacent to the light emitting element 100. One end of the waveguide element 200 far away from the light emitting element 100 turns and extends to a diagonal corner opposite to the light emitting element 100 along the corner of the touch area 400. Inside the waveguide element 200 that turns and extends to a diagonal corner opposite to the light emitting element 100, a reflecting surface 250 is fabricated at the turning corner. Thereby, the light rays can be reflected and transmitted by the reflecting surface to a diagonal corner opposite to the light emitting element 100 within the waveguide element 200.

Here, the light rays emitted from the light emitting element 100 are conducted by the two waveguide elements 200 to three sides of the touch area 400. Thus, the waveguide elements 200 are employed to emit and uniformly distribute the light rays from the light emitting element 100 to the touch area 400, so as to replace the conventional light-reflecting bars adapted to reflect the light rays emitted by the light emitting element 100. In this manner, the resistibility of the optical touch module against the ambient light sources is enhanced, thus avoiding interactive influences on the sensor 300 from the light rays emitted by the conventional light emitting element 100 and the light rays reflected by the light-reflecting bars. Meanwhile, the luminance of the light emitting element 100 is decreased, the current consumption is reduced, and the alignment accuracy of the optical touch module is also lowered.

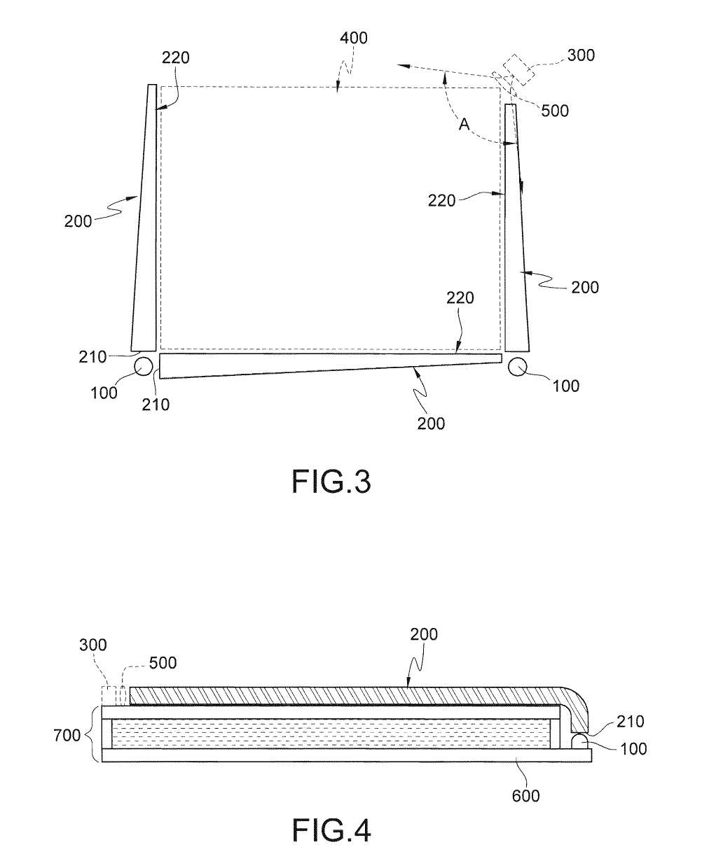

FIG. 3 is a top view of an optical touch module according to a third embodiment of the present invention.

Referring to FIG. 3 in combination with the above embodiment, in this embodiment, the optical touch module comprises two light emitting elements 100 and three waveguide elements 200.

In this embodiment, the touch area 400 is a rectangle (quadrangle). The sensor 300 is disposed at a corner of the touch area 400. One of the two light emitting elements 100 is disposed at a corner of the touch area 400 opposite to the sensor 300, and the other is disposed at a corner of the touch area 400 adjacent to the sensor 300.

One of the three waveguide elements 200 is disposed at one side of the touch area 400 located between the two light emitting elements 100. The other two of the three waveguide elements 200 are disposed at other sides of the touch area 400 adjacent to the light emitting elements 100, respectively.

According to the optical touch module provided by the present invention, after the two light emitting elements 100 emit light rays, the light rays are incident on the light incident surfaces 210 of the two waveguide elements 200 facing the light emitting elements 100 respectively, such that the light rays emitted from each light emitting element 100 are received. Due to the difference on the indexes of refraction between the waveguide element 200 and the ambient air, the light rays are confined within the three waveguide elements 200 for transmission. Eventually, the light rays exit the three waveguide elements 200 through the diffusion structure on the light emitting surface 220 and are distributed in the touch area 400. All the light rays within the touch area 400 are then received by the sensor 300 through the lens 500.

When a finger or any other contact object is placed on the touch area 400, a part of the light rays emitted from the light emitting surface 40 to the touch area 400 are blocked. Thus, when the sensor 300 is unable to receive the blocked light rays, a relative position of the finger or the contact object on the touch area 400 is determined.

Here, the three waveguide elements 200 are employed to uniformly distribute the light rays emitted by the two light emitting elements 100 to the touch area 400, so as to replace the conventional light-reflecting bars adapted to reflect the light rays emitted by the light emitting element 100. In this manner, the resistibility of the optical touch module against the ambient light sources is enhanced, thus avoiding interactive influences on the sensor 300 from the light rays emitted by the conventional light emitting element 100 and the light rays reflected by the light-reflecting bars. Meanwhile, the luminance of the light emitting element 100 is decreased, the current consumption is reduced, and the alignment accuracy of the optical touch module is also lowered.

FIG. 4 is a side view of an optical touch module according to a fourth embodiment of the present invention.

Referring to FIG. 4 in combination with the above embodiment, in this embodiment, the optical touch module comprises a substrate 600.

The substrate 600 is located below the touch area 400. The substrate 600 may be a printed circuit board (PCB) or an indium tin oxide (ITO) glass.

In this embodiment, the sensor 300, the touch area 400, and the lens 500 are located on a liquid crystal panel 700. The liquid crystal panel 700 may be formed by an ITO glass, a liquid crystal, a filter, and the like.

The light emitting element 100 is located on a surface of the ITO glass (i.e., the substrate 600) facing the touch area 400.

The waveguide element 200 is adjacent to the light emitting element 100. When the light rays emitted from the light emitting element 100 are incident on the waveguide element 200 through the light incident surface 210, the waveguide element 200 conducts the light rays to one side of the touch area 400.

As conducting lines and transistors on the ITO glass control liquid crystal deflection in the liquid crystal panel 700, the light emitting element 100 can be formed on the ITO glass together with the fabrication process of the ITO glass. Then, the waveguide element 200 is adapted to conduct the light rays from itself to the liquid crystal panel 700. Finally, the light rays exit the waveguide element 200 and are emitted to the touch area 400.

According to the optical touch module provided by the present invention, the light emitting element 100 is fabricated on the ITO glass (i.e., the substrate 600) of the liquid crystal panel. The waveguide element 200 is then adapted to confine the light rays emitted from the light emitting element 100 within the waveguide element 200 for transmission. Eventually, the light rays exit the waveguide element 200 and are distributed in the touch area 400. All the light rays within the touch area 400 are then received by the sensor 300 through the lens 500.

When a finger or any other contact object is placed on the touch area 400, a part of the light rays emitted from the light emitting surface 40 to the touch area 400 are blocked. Thus, when the sensor 300 is unable to receive the blocked light rays, a relative position of the finger or the contact object on the touch area 400 is determined.

Here, the light emitting element 100 is fabricated on the substrate 600, and the waveguide element 200 is employed to uniformly distribute the light rays emitted from the light emitting element 100 to the touch area 400. Thereby, the thickness of the optical touch module is reduced, and the cost of additionally fabricating the light emitting element on a PCB and the like is reduced.

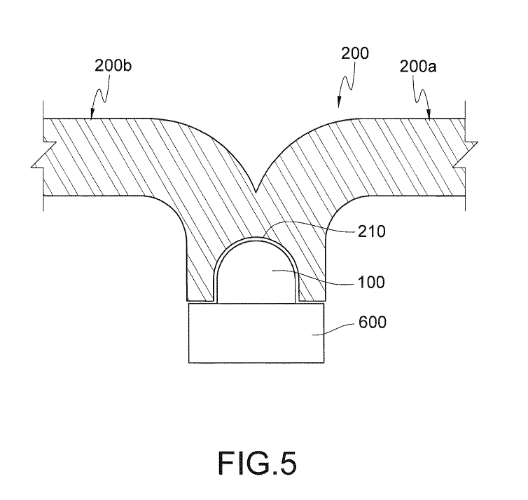

FIG. 5 is a schematic view of an adjacent area between a waveguide element and a light emitting element according to a fifth embodiment of the present invention.

Referring to FIG. 5 in combination with the fourth embodiment, in this embodiment, one end of the waveguide element 200 is provided with an accommodating area for accommodating the light emitting element 100, and the other end is divided into two sub-waveguide elements 200a, 200b extending toward two adjacent sides of the touch area 400, respectively. A shape of the accommodating area for accommodating the light emitting element 100 is corresponding to that of the light emitting element 100, and an inner wall of the accommodating area is the light incident surface 210.

The light rays emitted from the light emitting element 100 are incident on the waveguide element 200 through the light incident surface 210, and then conducted to the two adjacent sides of the touch area 400 through the two sub-waveguide elements 200a, 200b of the waveguide element.

Here, the light emitting element 100 is fabricated on the substrate 600, and the light rays emitted from the light emitting element 100 are received by the light incident surface 210 of the waveguide element 200. The light rays are respectively conducted to the two adjacent sides of the touch area 400 by the two sub-waveguide elements 200a, 200b within the waveguide element 200, and then emitted to the touch area 400. Thereby, the thickness of the optical touch module is reduced, and the cost of additionally fabricating the light emitting element on a PCB and the like is reduced.

According to the optical touch module provided by the present invention, the waveguide element 200 is employed to uniformly distribute the light rays emitted from the light emitting element 100 to the touch area 400. In this manner, the resistibility of the optical touch module against the ambient light sources is enhanced. Meanwhile, the luminance of the light emitting element 100 is decreased, the current consumption is reduced, and the alignment accuracy of the optical touch module is also lowered.

What is claimed is:

1. An optical touch module, adapted to provide a touch area, wherein at least one sensor is disposed at a corner of the touch area, the module comprising:
at least one light emitting element, for providing a light ray; and
at least one waveguide element, disposed on at least one side of the touch area, for guiding and emitting the light ray to the touch area, and each comprising:
a light incident surface, facing the at least one light emitting element; and
a light emitting surface, facing the touch area.

2. The optical touch module according to claim 1, wherein a shape of the light incident surface is corresponding to that of the at least one light emitting element.

3. The optical touch module according to claim 1, wherein the at least one light emitting element is located at a corner of the touch area opposite to the at least one sensor.

4. The optical touch module according to claim 1, further comprising:
a substrate, located below the touch area.

5. The optical touch module according to claim 4, wherein the at least one light emitting element is located on a surface of the substrate facing the touch area.

6. The optical touch module according to claim 4, wherein the substrate is an indium tin oxide (ITO) glass, and the at least one light emitting element is located on a surface of the substrate facing the touch area.

7. The optical touch module according to claim 1, wherein the light emitting surface has a diffusion structure.

8. The optical touch module according to claim 1, wherein the touch area is a polygon, and the at least one waveguide element is disposed at one side of the polygonal touch area.
